(19) United States
(12) Patent Application Publication
(10) Pub. No.: US 2024/0405323 A1
(43) Pub. Date: Dec. 5, 2024

(54) VEHICLE BATTERY TEMPERATURE CONTROL MECHANISM

(71) Applicant: SUBARU CORPORATION, Tokyo (JP)

(72) Inventor: Maya KAWABE, Tokyo (JP)

(21) Appl. No.: 18/666,526

(22) Filed: May 16, 2024

(30) Foreign Application Priority Data
Jun. 1, 2023 (JP) 2023-090862

(51) Int. Cl. H01M 10/6563; H01M 10/48; H01M 10/625; H01M 10/633

(52) U.S. Cl. CPC H01M 10/6563; H01M 10/482; H01M 10/486; H01M 10/625; H01M 10/633

(57) ABSTRACT

A vehicle battery temperature control mechanism is configured to control a temperature of a vehicle battery of a vehicle. The vehicle battery temperature control mechanism includes a battery set, an inlet, shutters, and a processor. The battery set includes battery modules arranged along a vehicle front-rear direction of the vehicle. The inlet is configured to allow outside air to be blown into the inlet. The shutters are provided together with the battery modules and configured to change between an open state in which the outside air blown in through the inlet hits the battery modules and a closed state in which flow of the outside air toward the battery modules is blocked. The processor is configured to perform an opening and closing control of controlling the shutters into the open state or the closed state.

### CROSS-REFERENCE TO RELATED APPLICATIONS

The present application claims priority from Japanese Patent Application No. 2023-090862 filed on Jun. 1, 2023, the entire contents of which are hereby incorporated by reference.

### BACKGROUND

The disclosure relates to a vehicle battery temperature control mechanism.

Vehicles including a high-voltage battery as a power source have usually been provided with a cooling unit for avoidance of deterioration due to a temperature rise, because a battery module exhibits a relatively significant temperature rise during charging and discharging. For example, reference is made to Japanese Patent (JP-B) No. 5494584. It is desired that an all-solid-state battery relatively resistant to heat among batteries be subjected to air cooling by outside air (including traveling wind), which is effective in terms of weight reduction and cost reduction, without relying on a relatively strong cooling capacity of, for example, a water-cooling system.

### SUMMARY

An aspect of the disclosure provides a vehicle battery temperature control mechanism configured to control a temperature of a vehicle battery of a vehicle. The vehicle battery temperature control mechanism includes a battery set, an inlet, shutters, and a processor. The battery set includes battery modules arranged along a vehicle front-rear direction of the vehicle. The inlet is configured to allow outside air to be blown into the inlet. The shutters are provided together with the battery modules and configured to change between an open state in which the outside air blown in through the inlet hits the battery modules and a closed state in which flow of the outside air toward the battery modules is blocked. The processor is configured to perform an opening and closing control of controlling the shutters into the open state or the closed state.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic side view of a vehicle including a battery temperature control mechanism according to one example embodiment.

FIG. 2 is a schematic side view of an exemplary battery pack in the battery temperature control mechanism according to one example embodiment.

FIG. 3 is a schematic top view of the exemplary battery pack in the battery temperature control mechanism according to one example embodiment.

FIG. 4 is a schematic diagram illustrating a control mechanism of a shutter opening and closing control in the battery temperature control mechanism according to one example embodiment.

FIG. 5 is a flowchart illustrating a shutter opening and closing control process in a traveling vehicle in the battery temperature control mechanism according to one example embodiment.

FIG. 6 is a flowchart illustrating a shutter opening and closing control process in a stopped vehicle in the battery temperature control mechanism according to one example embodiment.

FIG. 7 is a schematic side view of an exemplary battery pack in a battery temperature control mechanism according to one example embodiment.

FIG. 8 is a schematic top view of the exemplary battery pack in the battery temperature control mechanism according to one example embodiment.

FIG. 9 is a schematic side view of another exemplary battery pack in the battery temperature control mechanism according to one example embodiment.

FIG. 10 is a schematic top view of the other exemplary battery pack in the battery temperature control mechanism according to one example embodiment.

FIG. 11 is a flowchart illustrating a shutter opening and closing control process in a traveling vehicle in the battery temperature control mechanism according to one example embodiment.

FIG. 12 is a schematic side view illustrating a vehicle including a battery temperature control mechanism according to one example embodiment.

FIG. 13 is a schematic side view illustrating a vehicle including a battery temperature control mechanism according to one example embodiment.

FIG. 14 is a schematic side view of an exemplary battery pack in the battery temperature control mechanism according to one example embodiment.

FIG. 15 is a schematic top view of the exemplary battery pack in the battery temperature control mechanism according to one example embodiment.

### DETAILED DESCRIPTION

In existing air cooling by outside air (e.g., traveling wind) as disclosed in JP-B No. 5494584, a front battery module is directly hit by outside air and is thus easily cooled in many cases. In contrast, a rear battery module is hit by air heated by a battery module in front of the rear battery module and is thus difficult to cool. Accordingly, the battery module that is difficult to cool deteriorates easily and has a shorter battery life. In addition, temperature variations caused between multiple battery modules prevents a battery from being used up due to output restriction.

It is desirable to provide a vehicle battery temperature control mechanism that prolongs a battery life and makes it possible to use up a battery.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

In each drawing, a direction indicated by an arrow X (hereinafter also referred to as an “X direction”) is a front direction in a vehicle front-rear direction of a vehicle A, i.e., a vehicle forward direction. A direction indicated by an arrow Y (hereinafter also referred to as a “Y direction”) is a right direction in a vehicle width direction (a left-right direction) of the vehicle A. A direction indicated by an arrow Z (hereinafter also referred to as a “Z direction”) is an upper direction in an upper-lower direction (a height direction) of the vehicle A. A direction opposite to the X direction is a rear direction in the vehicle front-rear direction of the vehicle A, i.e., a vehicle backward direction. A direction opposite to the Y direction is a left direction in the vehicle width direction of the vehicle A. A direction opposite to the Z direction is a lower direction in the upper-lower direction (the height direction) of the vehicle A.

In each drawing, a front side is a side further to the X direction (a side further to the front direction), and a rear side is a side further to the direction opposite to the X direction (a side further to the rear direction). A right side is a side further to the Y direction (a side further to the right direction), and a left side is a side further to the direction opposite to the Y direction (a side further to the left direction). An upper side is a side further to the Z direction (a side further to the upper direction), and a lower side is a side further to the direction opposite to the Z direction (a side further to the lower direction). In addition, front/rear, left/right, and upper/lower may respectively refer to front/rear in the vehicle front-rear direction of the vehicle A, left/right in the vehicle width direction of the vehicle A, and upper/lower in the upper-lower direction (the height direction) of the vehicle A. The front in the vehicle front-rear direction of the vehicle A may simply be referred to as the “front”, and the rear in the vehicle front-rear direction of the vehicle A may simply be referred to as the “rear”.

### First Example Embodiment

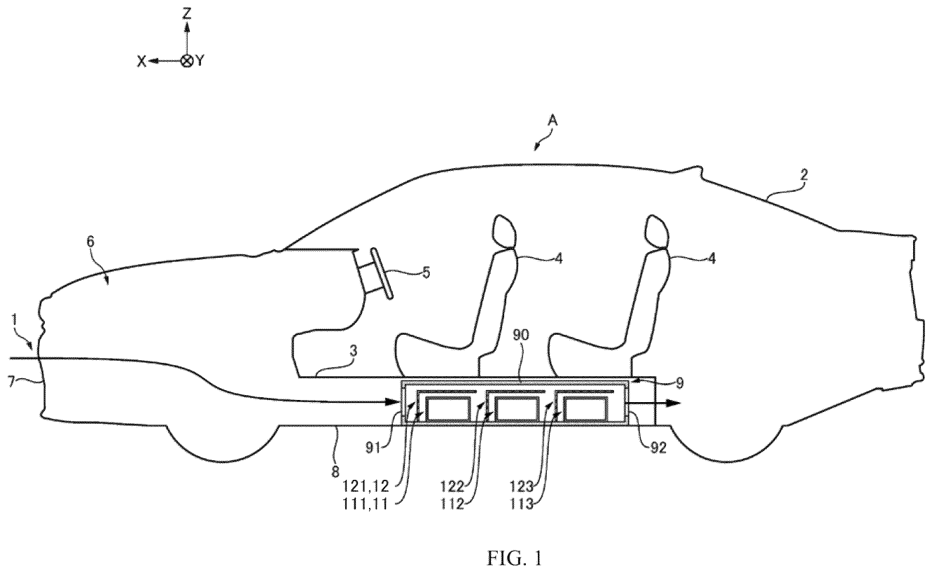

First, a vehicle battery temperature control mechanism (battery temperature control mechanism) 1 according to a first example embodiment of the disclosure will be described. FIG. 1 illustrates the vehicle A including the battery temperature control mechanism 1 according to the first example embodiment. The vehicle A may be an electric vehicle (EV) as an exemplary vehicle including a battery as a power source. Note that the vehicle A is not limited thereto, and may be any other vehicle including a battery as a power source, such as a hybrid electric vehicle or a fuel-cell vehicle. In one embodiment, the battery may serve as a “vehicle battery”.

As illustrated in FIG. 1, in a vehicle body 2 of the vehicle A, seats 4 including a driver's seat may be provided on a floor panel 3, and, for example, a steering wheel 5 for driving may be provided in front of the seats 4. Further, in a front part 6 of the vehicle body 2 may be provided unillustrated components including, for example, an engine, a motor, a heat exchanger (radiator), and an electronic control unit (ECU). The electronic control unit may be a processor 20 to be described later.

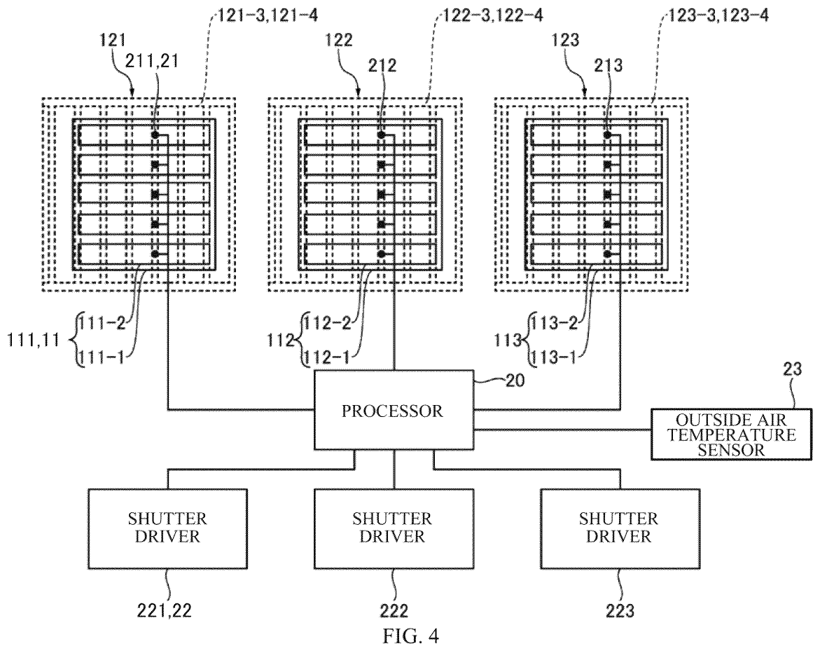

The battery temperature control mechanism 1 according to the first example embodiment may include a front grille opening 7 and a battery pack (battery container) 9. The front grille opening 7 may be positioned at the frontmost part of the vehicle body 2. The battery pack 9 may be provided below the floor panel 3, i.e. underfloor, on a bottom (under cover) 8. The battery temperature control mechanism 1 may also include the processor 20, shutter drivers 22, battery temperature sensors 21, and an outside air temperature sensor 23, which will be described later with reference to FIG. 4. A housing (case) 90 of the battery pack 9 may be fixed to the bottom 8 by, for example, an unillustrated bolt. In one embodiment, the front grille opening 7 may serve as an “inlet”.

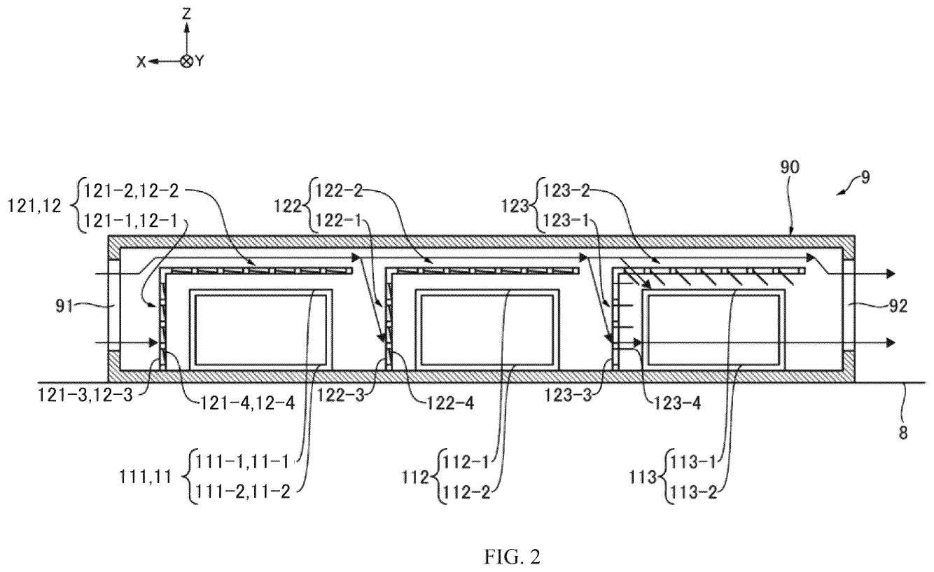

As indicated by solid-line arrows in FIGS. 1 and 2, the battery temperature control mechanism 1 may take in outside air (including traveling wind) from the front grille opening 7 on the front side in the vehicle front-rear direction, and exhaust the outside air from the rear side in the vehicle front-rear direction.

The housing 90 of the battery pack 9 may have a box shape having a length in the front-rear direction longer than a length in the left-right direction. A front side surface of the housing 90 may have a front opening 91, and a rear side surface of the housing 90 may have a rear opening 92. The battery pack 9 may contain, in the housing (case) 90, multiple battery modules 11 having substantially the same configuration as each other. In one embodiment, the battery modules 11 may serve as a “battery set”. The battery modules 11 may be arranged along the vehicle front-rear direction in the housing 90. In the example of FIGS. 1 and 2, three battery modules 11 (battery modules 111, 112, and 113) having substantially the same configuration as each other may be arranged along the vehicle front-rear direction in the housing 90. In FIG. 1, for simplified illustration, the reference numeral 11 is given to the battery module 111 as a representative. Similar simplified illustration applies to other corresponding parts in each drawing.

Further, in the housing 90 of the battery pack 9, shutters 12 (shutters 121, 122, and 123) having substantially the same configuration as each other may be provided together with the battery modules 11 (the battery modules 111, 112, and 113). The shutter 12 is configured to change between an open state in which outside air blown in through the front grille opening 7 hits the battery module 11, and a closed state in which the flow of the outside air toward the battery module 11 is blocked, as will be described later. The outside air may include traveling wind.

For example, while the vehicle A is traveling, outside air (traveling wind) blown into the front part 6 of the vehicle body 2 from the front grille opening 7 may flow in the vehicle backward direction, and flow into the housing 90 from the front opening 91 of the battery pack 9. when there is an open shutter 12, the outside air may flow in the vehicle backward direction while hitting the battery module 11 provided together with the shutter 12. Thereafter, the outside air may flow out of the housing 90 from the rear opening 92 to be discharged to the outside of the vehicle A. Note that “traveling” means that the vehicle A is traveling in the front direction (the vehicle forward direction or the X direction). Also in a case of outside air while the vehicle is stopped, when the outside air flows into the front part 6 of the vehicle body 2 through the front grille opening 7 of the vehicle A, the outside air may flow in a direction similar to that of the traveling wind to be discharged to the outside of the vehicle A.

As illustrated in FIGS. 2 and 4, the battery module 11 may include five battery cells 11-2 in a battery case 11-1. In other words, the battery module 111 may include five battery cells 111-2 in a battery case 111-1. The battery module 112 may include five battery cells 112-2 in a battery case 112-1. The battery module 113 may include five battery cells 113-2 in a battery case 113-1. The battery case 11-1 may have a structure that allows for ventilation between the inside and the outside. In the battery case 11-1, the battery cell 11-2 may be contained with a gap between the battery case 11-1 and each of an upper surface, a bottom surface, and front, rear, left, and right side surfaces of the battery cell 11-2. Note that the battery case 11-1 may have an unillustrated structure configured to contain the battery cell 11-2 while providing a gap between the battery case 11-1 and the bottom surface of the battery cell 11-2. The five battery cells 11-2 in the battery case 11-1 may be spaced from each other and arranged in parallel in a direction substantially orthogonal to the flow of traveling wind, i.e., the left-right direction.

The battery cell 11-2 may be, for example, an all-solid-state battery cell. The all-solid-state battery cell may include positive electrode active material powder, negative electrode active material powder, and solid electrolyte powder that are mixed and compressed. The all-solid-state battery cell may allow for temperature control within a temperature range of traveling wind. Note that the battery cell 11-2 is not limited thereto, and may be another battery cell, for example, a lithium-ion battery cell.

As illustrated in FIG. 2, in the housing 90 of the battery pack 9, the three battery modules 11 (the battery modules 111, 112, and 113) are spaced from each other along the vehicle front-rear direction, and the shutters 12 (the shutters 121, 122, and 123) may be provided together with the respective battery modules 11. In this manner, the battery pack 9 may include fifteen battery cells 11-2 spaced from each other.

Note that the number of the battery cells 11-2 arranged in the left-right direction in the battery module 11 is not limited to the above, and may be any number that is one or more. Further, the number of the battery modules 11 arranged in the vehicle front-rear direction (i.e., the number of the shutters 12 provided together with the battery modules) is not limited to the above, and may be any number that is two or more.

Here, a specific configuration of the shutter 12 is described. In the battery temperature control mechanism 1, the shutters 12 (the shutters 121, 122, and 123) may be provided together with the respective three battery modules 11 (battery modules 111, 112, and 113) arranged along the vehicle front-rear direction in the battery pack 9.

The shutter 12 (the shutters 121, 122, and 123) may include a front side part 12-1 (front side parts 121-1, 122-1, and 123-1) disposed in front of the battery module 11 (the battery modules 111, 112, and 113), and an upper part 12-2 (upper parts 121-2, 122-2, and 123-2) disposed above the battery module 11. The shutter 12 may have an L-shape in which an upper end of the front side part 12-1 and a front end of the upper part 12-2 are coupled to each other.

The shutter 12 may include, in the front side part 12-1 and the upper part 12-2, multiple openings 12-3 and movable shutter parts 12-4 provided for the respective openings 12-3. In other words, the shutter 121 may include multiple openings 121-3 and movable shutter parts 121-4 provided for the respective openings 121-3. The shutter 122 may include multiple openings 122-3 and movable shutter parts 122-4 provided for the respective openings 122-3. The shutter 123 may include multiple openings 123-3 and movable shutter parts 123-4 provided for the respective openings 123-3.

Each movable shutter part 12-4 may have one end in a short direction coupled to one end of the opening 12-3 in a short direction to be rotatable about an unillustrated rotary shaft. In the shutter 12, each movable shutter part 12-4 may rotate to change a tilt angle (an opening angle) with respect to an opening surface of the opening 12-3, to thereby change an opening state of the opening 12-3.

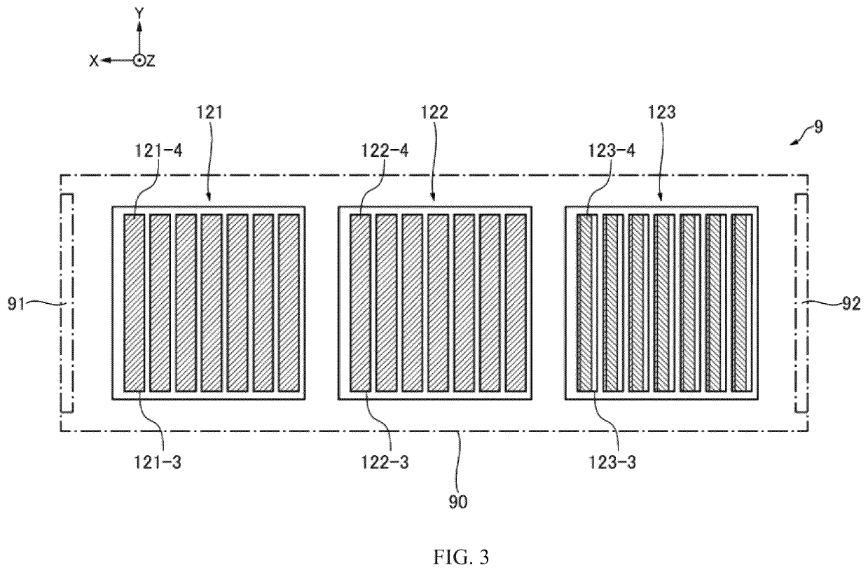

In the example illustrated in FIGS. 2 and 3, in the battery pack 9, all the movable shutter parts 121-4 and 122-4 of the shutters 121 and 122 provided together with the battery modules 111 and 112 may close (fully close) the openings 121-3 and 122-3. Accordingly, even when traveling wind from the front flows to hit the front side part 121-1 of the shutter 121 and the front side part 122-1 of the shutter 122 and flows along the upper part 121-2 of the shutter 121 and the upper part 122-2 of the shutter 122, the traveling wind does not pass through the openings 121-3 and 122-3. The traveling wind thus does not hit or hardly hits the battery modules 111 and 112.

In contrast, in the battery pack 9 of this example, all the movable shutter parts 123-4 of the shutter 123 provided together with the battery module 113 may each be disposed at the largest opening angle with respect to the opening surface of the opening 123-3. All the openings 123-3 may thus be in a state opened to the maximum (a fully open state). Accordingly, when traveling wind from the front flows to hit the front side part 123-1 of the shutter 123 and flows along the upper part 123-2 of the shutter 123, the traveling wind passes through the opening 123-3 and hits the battery module 113.

The battery temperature control mechanism 1 may perform an opening and closing control of the shutters 12 (shutters 121, 122, and 123) provided together with the battery modules 11 (the battery modules 111, 112, and 113) in the battery pack 9. Thus, the battery temperature control mechanism 1 may control the flow of traveling wind toward the battery module 11, to control the temperature of (perform temperature control on) the battery module 11.

An opening and closing control mechanism of the shutters 12 in the battery temperature control mechanism 1 according to the first example embodiment will be described with reference to FIG. 4. FIG. 4 illustrates the battery module 111 including the five battery cells 111-2 in the battery case 111-1, the battery module 112 including the five battery cells 112-2 in the battery case 112-1, and the battery module 113 including the five battery cells 113-2 in the battery case 113-1.

FIG. 4 also illustrates five battery temperature sensors 211, five battery temperature sensors 212, and five battery temperature sensors 213. The temperatures of the five battery cells 111-2 included in the battery module 111 may be detected by the battery temperature sensors 211 installed in the respective battery cells 111-2. The temperatures of the five battery cells 112-2 included in the battery module 112 may be detected by the battery temperature sensors 212 installed in the respective battery cells 112-2. The temperatures of the five battery cells 113-2 included in the battery module 113 may be detected by the battery temperature sensors 213 installed in the respective battery cells 113-2. In one embodiment, the battery temperature sensors 211, 212, and 213 may each serve as a “temperature sensor”.

In the battery temperature control mechanism 1, the processor 20 may be coupled via buses to the five battery temperature sensors 211 installed in the battery module 111, the five battery temperature sensors 212 installed in the battery module 112, and the five battery temperature sensors 213 installed in the battery module 113. In addition, the processor 20 may be coupled via a bus to the outside air temperature sensor 23 that detects an outside air temperature. The processor 20 may be coupled to the shutter drivers 22 (shutter drivers 221, 222, and 223) each including, for example, an actuator. The shutter driver 221 may rotationally drive the movable shutter parts 121-4 in the shutter 121, the shutter driver 222 may rotationally drive the movable shutter parts 122-4 in the shutter 122, and the shutter driver 223 may rotationally drive the movable shutter parts 123-4 in the shutter 123.

When temperature data of the battery cells 11-2 is supplied from the battery temperature sensors 21 installed in the respective five battery cells 11-2 of one battery module 11 (the battery module 111, 112, or 113), the processor 20 may identify the highest temperature among the temperatures indicated by the temperature data as a “battery maximum temperature tmax” of the battery module 11. The processor 20 may also identify the lowest temperature among the temperatures indicated by the supplied temperature data of the battery cells 11-2 as a “battery minimum temperature tmin” of the battery module 11. In other words, the processor 20 may identify the battery maximum temperature tmax and the battery minimum temperature tmin of the battery module 111 (the battery cells 111-2) based on the temperature data from the battery temperature sensors 211. The processor 20 may also identify the battery maximum temperature tmax and the battery minimum temperature tmin of the battery module 112 (the battery cells 112-2) based on the temperature data from the battery temperature sensors 212. The processor 20 may also identify the battery maximum temperature tmax and the battery minimum temperature tmin of the battery module 113 (the battery cells 113-2) based on the temperature data from the battery temperature sensors 213.

Note that the battery maximum temperature tmax and the battery minimum temperature tmin of one battery module 11 (the battery module 111, 112, or 113) are not limited to those identified in this manner. For example, one battery module 11 may have a maximum temperature expected point P1 at which the battery maximum temperature tmax is expected, and a minimum temperature expected point P2 at which the battery minimum temperature tmin is expected.

In this case, the battery temperature sensors 21 may detect the temperature of the maximum temperature expected point P1 and detect the temperature of the minimum temperature expected point P2 in one battery module 11 (the battery module 111, 112, or 113), and supply the temperature data to the processor 20. The processor 20 may identify the temperature indicated by the temperature data of the maximum temperature expected point P1 of one battery module 11 supplied from the battery temperature sensor 21 as the battery maximum temperature tmax of the battery module 11. In addition, the processor 20 may identify the temperature indicated by the temperature data of the minimum temperature expected point P2 of one battery module 11 supplied from the battery temperature sensor 21 as the battery minimum temperature tmin of the battery module 11.

The processor 20 may use values including the battery maximum temperature tmax and the battery minimum temperature tmin identified for one battery module 11 (the battery module 111, 112, or 113) to determine whether the shutter 12 (the shutter 121, 122, or 123) provided together with the battery module 11 is to be fully open or fully closed, and perform control to fully open or fully close the shutter 12 (121, 122, or 123) based on a determination result.

At this time, the processor 20 may supply data regarding the determination result of whether each of the shutters 12 (shutters 121, 122, and 123) is to be fully open or fully closed to the corresponding shutter driver 22 (shutter driver 221, 222, or 223). Based on the determination result, the shutter driver 22 may rotationally drive the corresponding movable shutter parts 12-4 (movable shutter parts 121-4, 122-4, or 123-4) on an as-needed basis, to fully open or fully close the openings 12-3 (the openings 121-3, 122-3, or 123-3).

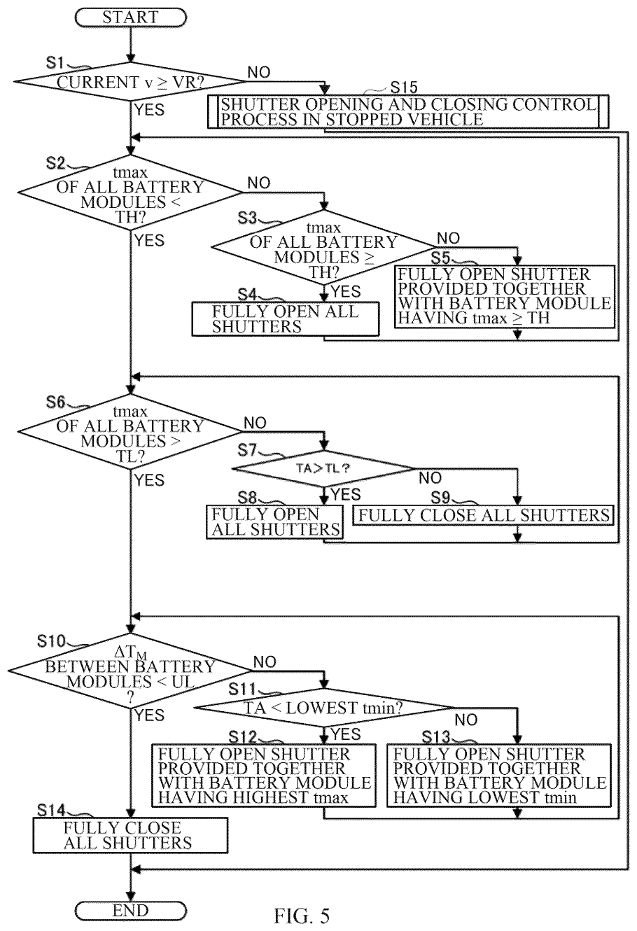

Next, a shutter opening and closing control process for controlling the temperature of (performing temperature control on) the battery module 11 when the vehicle is traveling will be described with reference to FIG. 5. Note that, in performing the series of processes illustrated in FIG. 5, the shutters 12 may be in a fully closed state immediately after an ignition (IG) power source is turned on (ON) in the vehicle A.

In step S1, the processor 20 may determine whether a current vehicle speed v (km/h) of the vehicle A is higher than or equal to a predetermined vehicle speed VR (km/h) in order to determine whether the vehicle A is currently traveling. The “predetermined vehicle speed VR” may be a preset vehicle speed that makes it possible to use traveling wind for the temperature control of the battery modules 11, and may be any value, for example, 30 km/h.

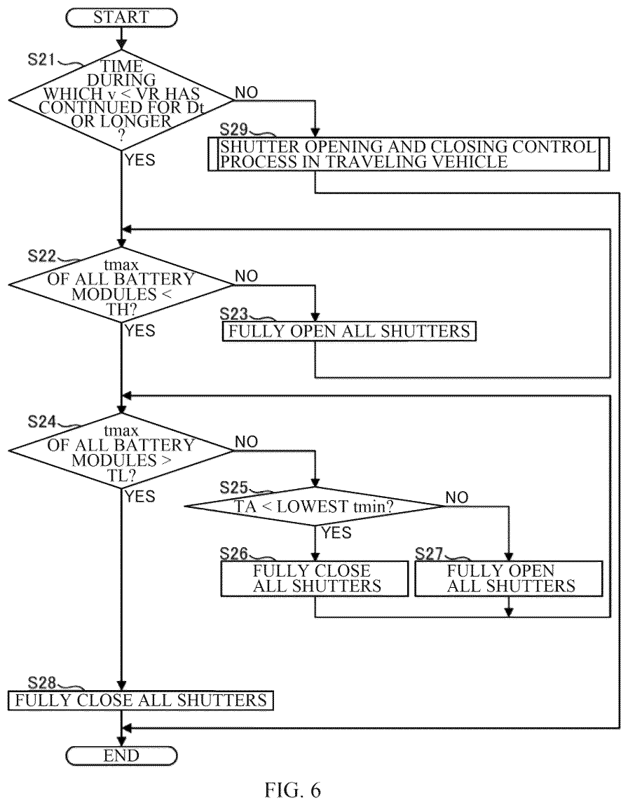

When the processor 20 determines that the current vehicle speed v of the vehicle A is higher than or equal to the predetermined vehicle speed VR (YES in step S1), the processor 20 may cause the process to proceed to step S2 to perform the shutter opening and closing control process while traveling in the vehicle A. When the processor 20 determines that the current vehicle speed v of the vehicle A is not higher than or equal to the predetermined vehicle speed VR, i.e., is lower than the predetermined vehicle speed VR (NO in step S1), the processor 20 may cause the process to shift to a shutter opening and closing control process in a stopped vehicle illustrated in FIG. 6 (step S15).

In step S2, the processor 20 may determine whether the battery maximum temperatures tmax of all the battery modules 11 (the battery modules 111, 112, and 113) included in the battery pack 9 are lower than a high-temperature-side threshold TH, in order to determine whether the battery module 11 in the battery pack 9 has to be cooled. The “high-temperature-side threshold TH” may be an upper limit of the temperature of the battery module 11 at which the battery module 11 is available without applying output restriction. Note that, when applying output restriction to the battery module 11, the processor 20 may restrict output electric power of the battery module 11 to less than or equal to a preset upper limit of the output electric power. The high-temperature-side threshold TH may be any value, for example, 60° C.

When the processor 20 determines that the battery module 11 in the battery pack 9 does not have to be cooled by determining that the battery maximum temperatures tmax of all the battery modules 11 (the battery modules 111, 112, and 113) included in the battery pack 9 are lower than the high-temperature-side threshold TH (YES in step S2), the processor 20 may cause the process to proceed to step S6 to determine whether the battery module 11 in the battery pack 9 has to be heated. When the processor 20 determines that the battery module 11 in the battery pack 9 has to be cooled by determining that the battery maximum temperature tmax of at least one of the battery modules 11 (the battery modules 111, 112, and 113) included in the battery pack 9 is not lower than the high-temperature-side threshold TH, i.e., is higher than or equal to the high-temperature-side threshold TH (NO in step S2), the processor 20 may cause the process to proceed to step S3 to determine which of the battery modules 11 in the battery pack 9 is to be cooled.

In step S3, the processor 20 may determine whether the battery maximum temperatures tmax of all the battery modules 11 (the battery modules 111, 112, and 113) included in the battery pack 9 are higher than or equal to the high-temperature-side threshold TH. When the processor 20 determines that the battery maximum temperatures tmax of all the battery modules 11 included in the battery pack 9 are higher than or equal to the high-temperature-side threshold TH (YES in step S3), the processor 20 may cause the process to proceed to step S4 to cool all the battery modules 11 included in the battery pack 9.

When the processor 20 determines that the battery maximum temperature tmax of at least one battery module 11, not all the battery modules 11, included in the battery pack 9 is higher than or equal to the high-temperature-side threshold TH (NO in step S3), the processor 20 may cause the process to proceed to step S5 to cool the battery module 11 having the battery maximum temperature tmax of higher than or equal to the high-temperature-side threshold TH.

In step S4, in order to cool all the battery modules 11 (the battery modules 111, 112, and 113) included in the battery pack 9 by traveling wind, the processor 20 may control the shutter drivers 22 (the shutter drivers 221, 222, and 223) to fully open the shutters 12 (the shutters 121, 122, and 123) provided together with the respective battery modules 11 (battery modules 111, 112, and 113). After the process of step S4, the processor 20 may cause the process to return to step S2. Such a state in which all the shutters 12 are fully open may continue until the battery maximum temperatures Tmax in all the battery modules 11 become lower than the high-temperature-side threshold TH.

In step S5, in order to cool the battery module 11 having the battery maximum temperature tmax of higher than or equal to the high-temperature-side threshold TH among the battery modules 11 (the battery modules 111, 112, and 113) included in the battery pack 9 by traveling wind, the processor 20 may control the corresponding shutter driver 22 to fully open the shutter 12 provided together with the battery module 11 having the battery maximum temperature tmax of higher than or equal to the high-temperature-side threshold TH. After the process of step S5, the processor 20 may cause the process to return to step S2. Such a state in which the corresponding shutter 12 is fully open may continue until the battery maximum temperatures Tmax in all the battery modules 11 become lower than the high-temperature-side threshold TH.

In step S6 after step S2, the processor 20 may determine whether the battery minimum temperatures tmin of all the battery modules 11 (the battery modules 111, 112, and 113) included in the battery pack 9 are higher than a low-temperature-side threshold TL, in order to determine whether the battery module 11 in the battery pack 9 has to be heated. The “low-temperature-side threshold TL” may be a lower limit of the temperature of the battery module 11 at which the battery module 11 is available without applying output restriction. The low-temperature-side threshold TL may be any value, for example, 10° C.

When the processor 20 determines that the battery minimum temperatures tmin of all the battery modules 11 included in the battery pack 9 are higher than the low-temperature-side threshold TL (YES in step S6), the processor 20 may cause the process to proceed to step S10. YES in step S6 indicates that all the battery modules 11 in the battery pack 9 are within an allowable temperature range where their temperatures are higher than the low-temperature-side threshold TL and lower than the high-temperature-side threshold TH. Accordingly, the processor 20 may cause the process to proceed to step S10 to determine whether temperature control (cooling or heating) has to be performed to reduce temperature variations between the battery modules 11 in the battery pack 9.

When the processor 20 determines that the battery minimum temperature tmin of at least one of the battery modules 11 (the battery modules 111, 112, and 113) included in the battery pack 9 is not higher than the low-temperature-side threshold TL, i.e., is lower than or equal to the low-temperature-side threshold TL (NO in step S6), the processor 20 may cause the process to proceed to step S7 to heat all the battery modules 11.

In step S7, the processor 20 may determine whether an outside air temperature TA detected by the outside air temperature sensor 23 is higher than the low-temperature-side threshold TL in order to determine whether the battery module 11 is able to be heated by traveling wind. When the processor 20 determines that the battery module 11 is able to be heated by traveling wind by determining that the outside air temperature TA detected by the outside air temperature sensor 23 is higher than the low-temperature-side threshold TL (YES in step S7), the processor 20 may cause the process to proceed to step S8.

In step S8, the processor 20 may control the shutter drivers 22 (the shutter drivers 221, 222, and 223) to fully open the shutters 12 (the shutters 121, 122, and 123) provided together with respective ones of all the battery modules 11 (the battery modules 111, 112, and 113) included in the battery pack 9. After the process of step S8, the processor 20 may cause the process to return to step S6. Thus, all the battery modules 11 may be heated by traveling wind introduced through the openings (the openings 121-3, 122-3, 123-3) of the shutters 12 (the shutters 121, 122, and 123) until their battery minimum temperatures tmin become higher than the low-temperature-side threshold TL.

In step S7, when the processor 20 determines that the battery module 11 is not able to be heated by traveling wind by determining that the outside air temperature TA detected by the outside air temperature sensor 23 is not higher than the low-temperature-side threshold TL, i.e., is lower than or equal to the low-temperature-side threshold TL (NO in step S7), the processor 20 may cause the process to proceed to step S9.

In step S9, the processor 20 may control the shutter drivers 22 (the shutter drivers 221, 222, and 223) to fully close all the shutters 12 (shutters 121, 122, and 123). After the process of step S9, the processor 20 may cause the process to return to step S6. In this manner, by the corresponding shutters 12 being fully closed, all the battery modules 11 may be naturally heated by air in the battery pack 9 or self-heating resulting from a battery driving current. Such a state in which all the shutters 12 are fully closed may continue until the battery minimum temperatures tmin in all the battery modules 11 become higher than the low-temperature-side threshold TL.

In step S10 after step S6, the processor 20 may determine whether a maximum temperature difference ATM between the battery modules 11 is less than a temperature difference upper limit UL, between the battery modules 11 (the battery modules 111, 112, and 113) included in the battery pack 9, in order to determine whether the temperature variations between the battery modules 11 (the battery modules 111, 112, and 113) have to be reduced.

The “maximum temperature difference ATM” may be a difference between the highest battery maximum temperature tmax of the battery maximum temperatures tmax in the respective battery modules 11 in the battery pack 9 and the lowest battery minimum temperature tmin of the battery minimum temperatures tmin in the respective battery modules 11 in the battery pack 9. The “temperature difference upper limit UL” may be an upper limit of a temperature difference (an allowable temperature difference) that is allowable between the battery modules 11 (the battery modules 111, 112, and 113). The temperature difference upper limit UL may be any value, for example, 5° C.

When the processor 20 determines that the maximum temperature difference ATM between the battery modules 11 is not less than the temperature difference upper limit UL, i.e., is greater than or equal to the temperature difference upper limit UL, between the battery modules 11 (the battery modules 111, 112, and 113) included in the battery pack 9 (NO in step S10), the processor 20 may cause the process to proceed to step S11, because temperature control (cooling or heating) for reducing the temperature variations between the battery modules 11 in the battery pack 9 has to be performed.

In step S11, the processor 20 may determine whether the outside air temperature TA detected by the outside air temperature sensor 23 is lower than the lowest battery minimum temperature tmin of the battery minimum temperatures tmin in all the battery modules 11 (the battery modules 111, 112, and 113) included in the battery pack 9, in order to determine whether to reduce the temperature variations between the battery modules 11 (the battery modules 111, 112, and 113) by cooling by traveling wind or by heating by traveling wind.

When the processor 20 determines that the outside air temperature TA detected by the outside air temperature sensor 23 is lower than the lowest battery minimum temperature tmin of the battery minimum temperatures tmin in all the battery modules 11 (the battery modules 111, 112, and 113) included in the battery pack 9 (YES in step S11), the processor 20 may cause the process to proceed to step S12 to reduce the temperature variations between the battery modules 11 by cooling by traveling wind.

When the processor 20 determines that the outside air temperature TA detected by the outside air temperature sensor 23 is not lower than (i.e., is higher than or equal to) the lowest battery minimum temperature tmin of the battery minimum temperatures tmin in all the battery modules 11 (the battery modules 111, 112, and 113) included in the battery pack 9 (NO in step S11), the processor 20 may cause the process to proceed to step S13 to reduce the temperature variations between the battery modules 11 by heating by traveling wind.

In step S12, the processor 20 may control the corresponding shutter driver 22 to fully open the shutter 12 provided together with the battery module 11 having the highest battery maximum temperature tmax among all the battery modules 11 (the battery modules 111, 112, and 113) included in the battery pack 9. This causes the battery module 11 having the highest battery maximum temperature tmax to be cooled by traveling wind. After the process of step S12, the processor 20 may cause the process to return to step S10. In this manner, the battery module 11 having the highest battery maximum temperature tmax may be cooled by traveling wind until the maximum temperature difference ATM between the battery modules 11 becomes less than the temperature difference upper limit UL between the battery modules 11 (the battery modules 111, 112, and 113). This reduces the temperature variations between the battery modules 11 (the battery modules 111, 112, and 113).

In step S13, the processor 20 may control the corresponding shutter driver 22 to fully open the shutter 12 provided together with the battery module 11 having the lowest battery minimum temperature tmin among all the battery modules 11 (the battery modules 111, 112, and 113) included in the battery pack 9. This causes the battery module 11 having the lowest battery minimum temperature tmin to be heated by traveling wind. After the process of step S13, the processor 20 may cause the process to return to step S10. In this manner, the battery module 11 having the lowest battery minimum temperature tmin may be heated by traveling wind until the maximum temperature differential ATM between the battery modules 11 becomes less than the temperature difference upper limit UL between the battery modules 11 (the battery modules 111, 112, and 113). This reduces the temperature variations between the battery modules 11 (the battery modules 111, 112, and 113).

When the processor 20 determines that the maximum temperature difference ATM between the battery modules 11 is less than the temperature difference upper limit UL between the battery modules 11 (the battery modules 111, 112, and 113) included in the battery pack 9 (YES in step S10), the processor 20 may cause the process to proceed to step S14, because the temperature variations between the battery modules 11 (the battery modules 111, 112, and 113) do not have to be reduced by traveling wind.

In step S14, the processor 20 may fully close all the shutters 12 (shutters 121, 122, and 123). In other words, in step S14, if there is an open (fully open) shutter 12, the processor 20 may control the shutter driver 22 to fully close the shutter 12. After the process of step S14, the processor 20 may end the series of processes of FIG. 5. Note that, when the processor 20 ends the series of processes of FIG. 5, the processor 20 may start the series of processes of FIG. 5 at a predetermined timing of measuring the vehicle speed v (km/h). When the ignition (IG) power source is turned off (OFF) in the vehicle A in the middle of the series of processes illustrated in FIG. 5, if there is an open shutter 12 at that time, the processor 20 may perform control to fully close the shutter 12.

Next, a shutter opening and closing control process (step S15 illustrated in FIG. 5) for performing temperature control on the battery modules 11 when the vehicle is stopped will be described with reference to FIG. 6. In step S21 illustrated in FIG. 6, the processor 20 may determine whether a time during which the vehicle speed v (km/h) of the vehicle A is lower than the predetermined vehicle speed VR (km/h) has continued for a predetermined time Dt or longer, in order to determine whether the vehicle A is currently stopped. The “predetermined time Dt” may be, for example, a relatively long time such as while the vehicle is parked, not a relatively short time such as while waiting at a traffic light. The “predetermined time Dt” may be any value, for example, 5 minutes.

When the processor 20 determines that the time during which the vehicle speed v (km/h) of the vehicle A is lower than the predetermined vehicle speed VR (km/h) has continued for the predetermined time Dt or longer (YES in step S21), the processor 20 may cause the process to proceed to step S22 to perform the shutter opening and closing control process while being stopped in the vehicle A. When the processor 20 determines that the time during which the vehicle speed v (km/h) of the vehicle A is lower than the predetermined vehicle speed VR (km/h) has not continued for the predetermined time Dt or longer, i.e., is shorter than the specified time Dt (NO in step S21), the processor 20 may cause the process to shift to the shutter opening and closing control process in a traveling vehicle illustrated in FIG. 5 (step S29).

In step S22, the processor 20 may determine whether the battery maximum temperatures tmax of all the battery modules 11 (the battery modules 111, 112, and 113) included in the battery pack 9 are lower than a high-temperature-side threshold TH, in order to determine whether the battery module 11 in the battery pack 9 has to be cooled.

When the processor 20 determines that the battery module 11 in the battery pack 9 does not have to be cooled by determining that the battery maximum temperatures tmax of all the battery modules 11 (the battery modules 111, 112, and 113) included in the battery pack 9 are lower than the high-temperature-side threshold TH (YES in step S22), the processor 20 may cause the process to proceed to step S24 to determine whether the battery module 11 in the battery pack 9 has to be heated. When the processor 20 determines that the battery module 11 in the battery pack 9 has to be cooled by determining that the battery maximum temperature tmax of at least one of the battery modules 11 (the battery modules 111, 112, and 113) included in the battery pack 9 is not lower than the high-temperature-side threshold TH, i.e., is higher than or equal to the high-temperature-side threshold TH (NO in step S22), the processor 20 may cause the process to proceed to step S23 to cool all the battery modules 11 in the battery pack 9.

In step S23, the processor 20 may control the shutter drivers 22 (the shutter drivers 221, 222, and 223) to fully open the shutters 12 (the shutters 121, 122, and 123) provided together with respective ones of all the battery modules 11 (the battery modules 111, 112, and 113) included in the battery pack 9. After the process of step S23, the processor 20 may cause the process to return to step S22. In this manner, all the battery modules 11 in the battery pack 9 may be cooled by outside air by the shutters 12 provided together with the battery modules 11 being fully opened. Such a state in which all the shutters 12 are fully open may continue until the battery maximum temperatures Tmax in all the battery modules 11 become lower than the high-temperature-side threshold TH.

In step S24 after step S22, the processor 20 may determine whether the battery minimum temperatures tmin of all the battery modules 11 (the battery modules 111, 112, and 113) included in the battery pack 9 are higher than a low-temperature-side threshold TL, in order to determine whether the battery module 11 in the battery pack 9 has to be heated.

When the processor 20 determines that the battery module 11 in the battery pack 9 does not have to be heated by determining that the battery minimum temperatures tmin of all the battery modules 11 (the battery modules 111, 112, and 113) included in the battery pack 9 are higher than the low-temperature-side threshold TL (YES in step S24), the processor 20 may cause the process to proceed to step S28.

When the processor 20 determines that the battery minimum temperature tmin of at least one of the battery modules 11 (the battery modules 111, 112, and 113) included in the battery pack 9 is not higher than the low-temperature-side threshold TL, i.e., is lower than or equal to the low-temperature-side threshold TL (NO in step S24), the processor 20 may cause the process to proceed to step S25 to heat all the battery modules 11.

In step S25, the processor 20 may determine whether the outside air temperature TA detected by the outside air temperature sensor 23 is lower than the lowest battery minimum temperature tmin of the battery minimum temperatures tmin in all the battery modules 11 (the battery modules 111, 112, and 113) included in the battery pack 9, in order to determine whether the battery module 11 (the battery modules 111, 112, and 113) is able to be heated by outside air.

When the processor 20 determines that the battery module 11 (the battery modules 111, 112, and 113) is not able to be heated by outside air by determining that the outside air temperature TA detected by the outside air temperature sensor 23 is lower than the lowest battery minimum temperature tmin (YES in step S25), the processor 20 may cause the process to proceed to step S26. When the processor 20 determines that the battery module 11 (the battery modules 111, 112, and 113) is able to be heated by outside air by determining that the outside air temperature TA detected by the outside air temperature sensor 23 is not lower than the lowest battery minimum temperature tmin, i.e., is higher than or equal to the battery minimum temperature tmin (NO in step S25), the processor 20 may cause the process to proceed to step S27.

In step S26, the processor 20 may control the shutter drivers 22 (the shutter drivers 221, 222, and 223) to put all the shutters 12 (shutters 121, 122, and 123) included in the battery pack 9 into a fully closed state. After the process of step S26, the processor 20 may cause the process to return to step S24. In this manner, by the shutters 12 provided together with the battery modules 11 being fully closed, all the battery modules 11 in the battery pack 9 may be naturally heated by air in the battery pack 9 or self-heating resulting from a battery driving current. Such a state in which all the shutters 12 are fully closed may continue until the battery minimum temperatures tmin in all the battery modules 11 become higher than the low-temperature-side threshold TL.

In step S27, the processor 20 may control the shutter drivers 22 (the shutter drivers 221, 222, and 223) to fully open all the shutters 12 (shutters 121, 122, and 123) included in the battery pack 9. After the process of step S27, the processor 20 may cause the process to return to step S24. In this manner, all the battery modules 11 in the battery pack 9 may be heated by outside air by the shutters 12 provided together with the battery modules 11 being fully opened. Such a state in which all the shutters 12 are fully open may continue until the battery minimum temperatures tmin in all the battery modules 11 become higher than the low-temperature-side threshold TL.

In step S28 after step S24, the processor 20 may fully close all the shutters 12 (shutters 121, 122, and 123). In other words, in step S28, if there is an open (fully open) shutter 12, the processor 20 may control the shutter driver 22 to fully close the shutter 12. After the process of step S28, the processor 20 may end the series of processes of FIG. 6. Note that, when the processor 20 ends the series of processes of FIG. 6, the processor 20 may start the series of processes of FIG. 5 (step S29) at a predetermined timing of measuring the vehicle speed v (km/h).

As described above, in the battery temperature control mechanism 1 according to the first example embodiment, it is possible to prevent the battery modules 11 from deteriorating due to a temperature rise and thereby prolong a battery life by merely providing a simple structure such as the shutters 12, without providing a complicated cooling mechanism. Further, it is possible to avoid output restriction by suppressing the temperature variation between the battery modules 11, making it possible to use up the battery. The battery temperature control mechanism 1 described above is useful, for example, when the battery cell 11-2 is an all-solid-state battery cell that allows for temperature control within the temperature range of outside air (including traveling wind).

### Second Example Embodiment

Next, a second example embodiment of the disclosure will be described. In the second example embodiment, the battery temperature control mechanism 1 may be similar to that in the first example embodiment but may differ in the opening and closing control process of the shutters 12. Description of configurations and control details in the second example embodiment that are the same as those in the first example embodiment will be omitted as appropriate.

In the first example embodiment described above, when opening the shutter 12 (the shutter 121, 122, or 123), the shutter 12 to be opened may be opened in a fully open state. In contrast, in the second example embodiment, when opening the shutter 12, an opening level serving as an index of a degree of opening of the movable shutter part 121-4, 122-4, or 123-4 may be determined for the shutter 12 to be opened, and the shutter 12 may be opened with a size (the opening angle of the movable shutter part 121-4, 122-4, or 123-4) corresponding to the opening level.

For example, the processor 20 may set a priority order of cooling or heating by outside air (including traveling wind) in order for the battery module 11 that has to be subjected to temperature control by outside air (including traveling wind), based on values including the battery maximum temperature tmax and the battery minimum temperature tmin. The processor 20 may determine the opening level for the shutter 12 provided together with the battery module 11, to make the opening level of the shutter 12 provided together larger for the battery module 11 having the higher priority order. The opening level may include a “large (fully open)” level, a “medium level”, and a “small level”.

The processor 20 may supply data regarding the determined opening level to the corresponding shutter driver 22. The shutter driver 22 may rotate each movable shutter part 12-4 to the tilt angle (the opening angle) corresponding to the opening level, to open each opening 12-3 into an opening state with a size corresponding to the opening angle.

In addition, for the battery module 11 that does not have to be subjected to temperature control by outside air (including traveling wind), the processor 20 may supply data regarding a determination result that the shutter 12 provided together is to be fully closed to the corresponding shutter driver 22, based on values including the battery maximum temperature tmax, and the battery minimum temperature tmin. Based on the determination result, the shutter driver 22 may rotationally drive the movable shutter parts 12-4 of the shutter 12 on an as-needed basis to fully close the openings 12-3 of the shutter 12.

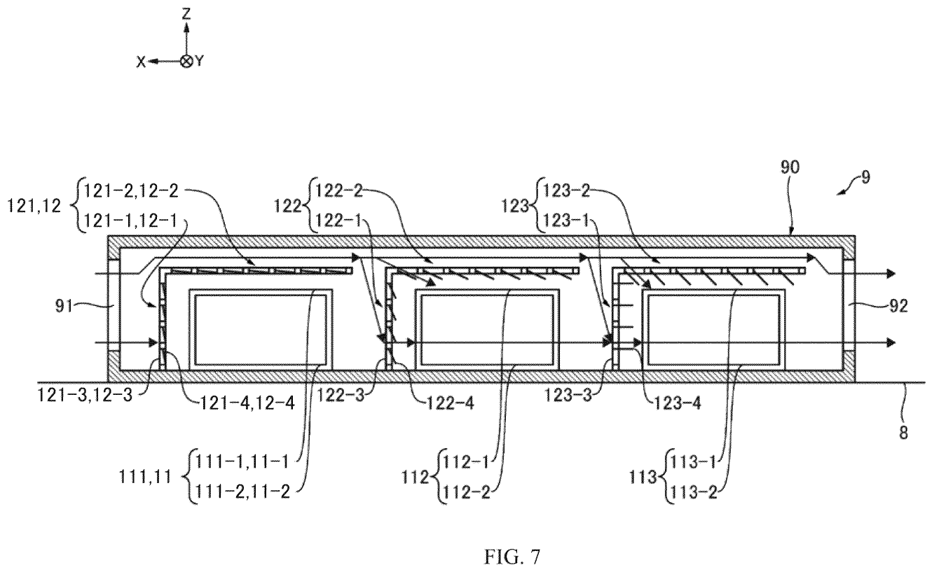

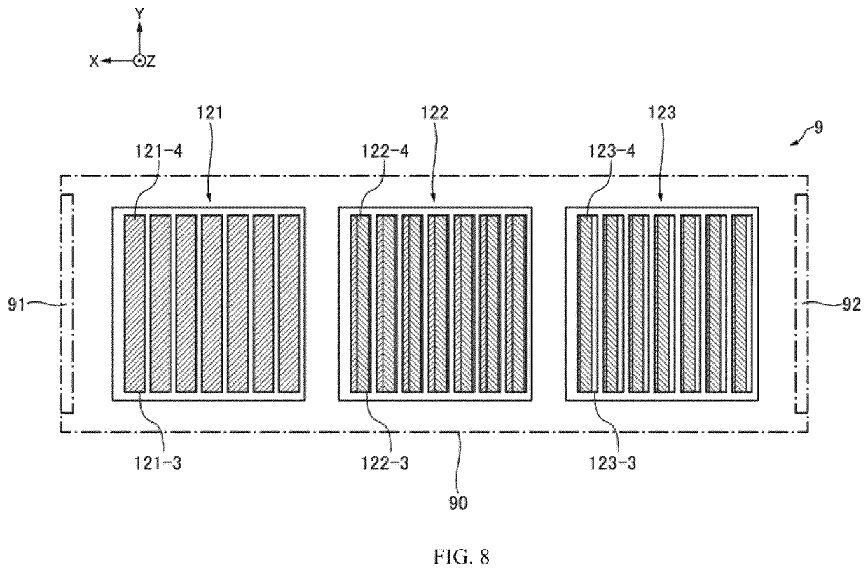

For example, as illustrated in FIGS. 7 and 8, in the battery pack 9, all the movable shutter part 121-4 of the shutter 121 provided together with the battery module 111 positioned furthest in the front in the vehicle front-rear direction may close (fully close) the opening 121-3. Thus, even if outside air (including traveling wind) flows in from the front, the battery module 111 is not hit or hardly hit by the outside air (including traveling wind) because the outside air does not pass through the opening 12-3 of the shutter 12.

Further, as illustrated in FIGS. 7 and 8, in the battery pack 9, the shutter 122 provided together with the battery module 112 positioned in the substantially middle in the vehicle front-rear direction may have the “small level” determined as the opening level. All the movable shutter parts 122-4 of the shutter 122 may each be disposed at the opening angle corresponding to the determined “small level” with respect to the opening surface of the opening 122-3, to put all the openings 122-3 into a state opened to the minimum (the opening state “small”).

Further, as illustrated in FIGS. 7 and 8, in the battery pack 9, the shutter 123 provided together with the battery module 113 positioned furthest in the rear in the vehicle front-rear direction may have the large (fully open) level determined as the opening level. All the movable shutter parts 123-4 of the shutter 123 may each be disposed at the opening angle corresponding to the determined “large level” with respect to the opening surface of the opening 123-3, to put all the openings 123-3 into a state opened to the maximum (the opening state “large (fully open)”).

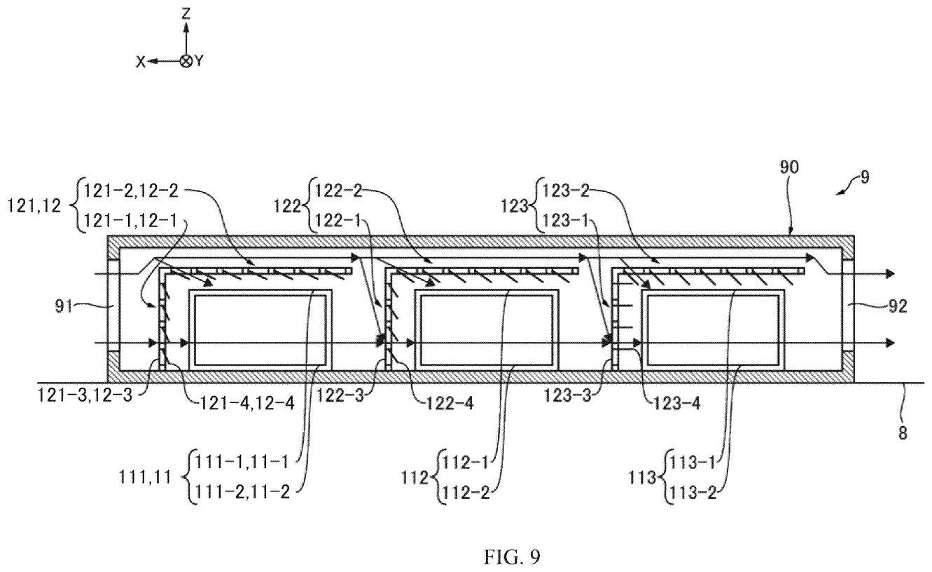

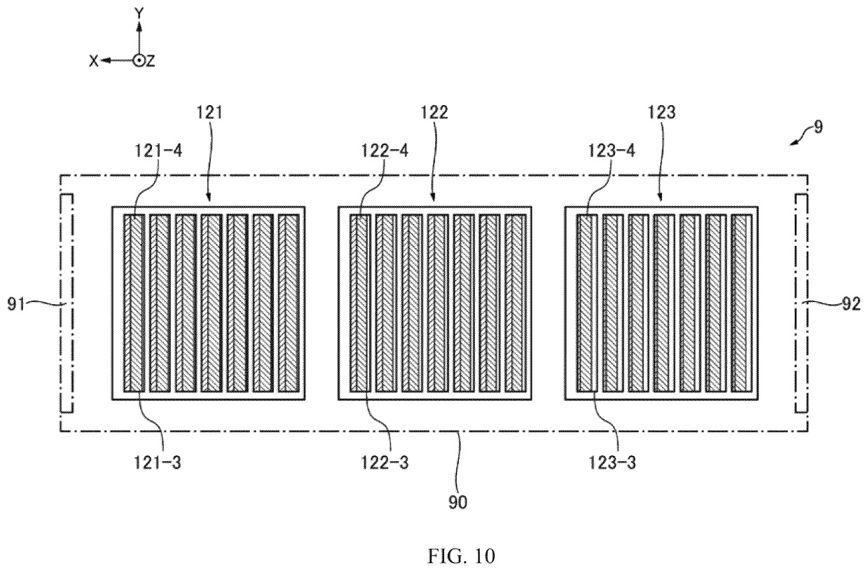

As another example, as illustrated in FIGS. 9 and 10, in the battery pack 9, all the openings 121-3 of the shutter 121 provided together with the battery module 111 positioned furthest in the front in the vehicle front-rear direction may be opened in the opening state “small” in accordance with the opening level “small level”. All the openings 123-3 of the shutter 123 provided together with the battery module 113 positioned furthest in the rear in the vehicle front-rear direction may be opened in the opening state “large (fully open)” in accordance with the opening level “large level”.

Further, in the battery pack 9 illustrated in FIGS. 9 and 10, the shutter 122 provided together with the battery module 112 positioned in substantially the middle in the vehicle front-rear direction may have the “medium level” determined as the opening level. All the movable shutter part 122-4 of the shutter 122 may each be disposed at the opening angle corresponding to the determined “medium level” with respect to the opening surface of the opening 122-3, to put all the openings 122-3 into a state moderately opened (the opening state “medium”).

As illustrated in the examples of FIGS. 7 to 10, as the opening state of the opening 12-3 increases in the order of “small”, “medium”, and “large”, outside air (including traveling wind) flowing into the battery pack 9 from the front more easily passes through the opening 12-3 of the shutter 12 (an air volume passing through the opening 12-3 increases), causing the outside air (including traveling wind) to further hit the battery module 11 provided together.

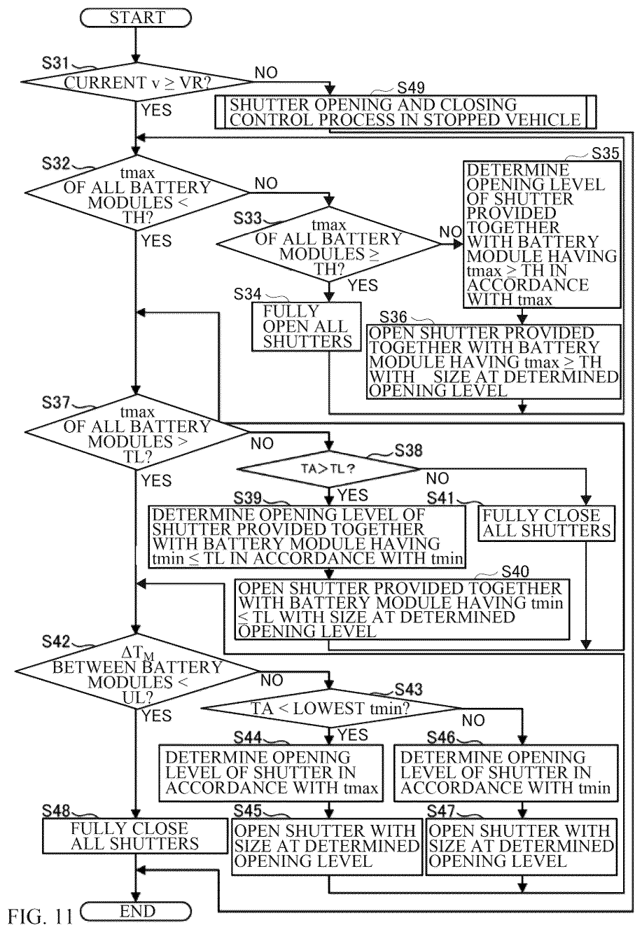

Next, a shutter opening and closing control process for performing temperature control on the battery modules 11 when the vehicle is traveling according to the second example embodiment will be described with reference to FIG. 11. As illustrated in FIG. 11, in steps S31 to S34, the processor 20 may perform the same processes as steps S1 to S4 of FIG. 5.

In step S31, the processor 20 may cause the process to proceed to step S32 in response to YES, and cause the process to shift to the shutter opening and closing control process in a stopped vehicle illustrated in FIG. 6 (step S49) in response to NO. In step S32, the processor 20 may cause the process to proceed to step S37 in response to YES and cause the process to proceed to step S33 in response to NO. In step S33, the processor 20 may cause the process to proceed to step S34 in response to YES and cause the process to proceed to step S35 in response to NO. The processor 20 may cause the process to return to step S32 after the process of step S34.

In step S35, in order to cool the battery module 11 having the battery maximum temperature tmax of higher than or equal to the high-temperature-side threshold TH among the battery modules 11 (the battery modules 111, 112, and 113) included in the battery pack 9, the processor 20 may set the priority order of cooling by traveling wind in order from the battery module 11 with the higher battery maximum temperature tmax, for the battery module 11 having the battery maximum temperature tmax of higher than or equal to the high-temperature-side threshold TH. Regarding the battery module 11 having the battery maximum temperature tmax of higher than or equal to the high-temperature-side threshold TH, the processor 20 may determine the opening level for the shutter 12 provided together with the battery module 11, to make the opening level of the shutter 12 provided together larger, by further cooling by traveling wind, for the battery module 11 having the higher priority order (i.e., the higher battery maximum temperature tmax). The opening level may include the “large (fully open) level”, the “medium level”, and the “small level”.

For example, assume that the battery maximum temperatures tmax of the battery modules 111, 112, and 113 increase in this order (i.e., the battery module 113 has the highest battery maximum temperature tmax), and that the battery maximum temperatures tmax of the battery modules 112 and 113 are higher than or equal to the high-temperature-side threshold TH. In this case, in step S35, the processor 20 may set the priority order of cooling by traveling wind in the order of the battery modules 113 and 112. The processor 20 may, for example, determine the “large level” as the opening level of the shutter 123 and the “medium level” as the opening level of the shutter 122. Note that the opening level is not limited thereto and, for example, the “large level” may be determined as the opening level of the shutter 123 and the “small level” may be determined as the opening level of the shutter 122.

In step S36, the processor 20 may supply data regarding the opening level determined in step S35 to the shutter driver 22 for the shutter 12 provided together with the battery module 11 having the battery maximum temperature tmax of higher than or equal to the high-temperature-side threshold TH, to thereby control the shutter driver 22. The shutter driver 22 that has received the supplied data regarding the opening level may rotate each movable shutter part 12-4 to the tilt angle (the opening angle) corresponding to the opening level, to open each opening 12-3 into an opening state with a size corresponding to the opening angle, thereby cooling the battery module 11 by traveling wind. After the process of step S36, the processor 20 may cause the process to return to step S32.

Further, as illustrated in FIG. 11, the processor 20 may perform the same process as step S6 of FIG. 5 in step S37, perform the same process as step S7 of FIG. 5 in step S38, and perform the same process as step S9 of FIG. 5 in step S41. In step S37, the processor 20 may cause the process to proceed to step S42 in response to YES and cause the process to proceed to step S38 in response to NO. In step S38, the processor 20 may cause the process to proceed to step S39 in response to YES and cause the process to proceed to step S41 in response to NO. After the process of step S41, the processor 20 may cause the process to return to step S37.

In step S39, in order to heat the battery module 11 having the battery minimum temperature tmin of lower than or equal to the low-temperature-side threshold TL among the battery modules 11 (the battery modules 111, 112, and 113) included in the battery pack 9, the processor 20 may set the priority order of heating by traveling wind in order from the battery module 11 with the lower battery minimum temperature tmin, for the battery module 11 having the battery minimum temperature tmin of lower than or equal to the low-temperature-side threshold TL. Regarding the battery module 11 having the battery minimum temperature tmin of lower than or equal to the low-temperature-side threshold TL, the processor 20 may determine the opening level for the shutter 12 provided together with the battery module 11, to make the opening level of the shutter 12 provided together larger, by further heating by traveling wind, for the battery module 11 having the higher priority order (i.e., the lower battery minimum temperature tmin). The opening level may include the “large (fully open) level”, the “medium level”, and the “small level”.

For example, assume that the battery minimum temperatures tmin of the battery modules 113, 112, and 111 decrease in this order (i.e., the battery module 111 has the lowest battery minimum temperature tmin), and that the battery minimum temperatures tmin of the battery modules 111 and 112 are lower than or equal to the low-temperature-side threshold TL. In this case, in step S39, the processor 20 may set the priority order of heating by traveling wind in the order of the battery modules 111 and 112. The processor 20 may, for example, determine the “large level” as the opening level of the shutter 121 and the “medium level” as the opening level of the shutter 122. Note that the opening level is not limited thereto and, for example, the “large level” may be determined as the opening level of the shutter 121 and the “small level” may be determined as the opening level of the shutter 122.

In step S40, the processor 20 may supply data regarding the opening level determined in step S39 to the shutter driver 22 for the shutter 12 provided together with the battery module 11 having the battery minimum temperature tmin of lower than or equal to the low-temperature-side threshold TL, to thereby control the shutter driver 22. The shutter driver 22 that has received the supplied data regarding the opening level may rotate each movable shutter part 12-4 to the tilt angle (the opening angle) corresponding to the opening level, to open each opening 12-3 into an opening state with a size corresponding to the opening angle, thereby heating the battery module 11 by traveling wind. After the process of step S40, the processor 20 may cause the process to return to step S37.

Further, as illustrated in FIG. 11, the processor 20 may perform the same process as step S10 of FIG. 5 in step S42, perform the same process as step S11 of FIG. 5 in step S43, and perform the same process as step S14 of FIG. 5 in step S48. In step S42, the processor 20 may cause the process to proceed to step S48 in response to YES and cause the process to proceed to step S43 in response to NO. In step S43, the processor 20 may cause the process to proceed to step S44 in response to YES and cause the process to proceed to step S46 in response to NO. After the process of step S48, the processor 20 may end the series of processes of FIG. 11. Note that, when the processor 20 ends the series of processes of FIG. 11, the processor 20 may start the series of processes of FIG. 11 at a predetermined timing of measuring the vehicle speed v (km/h).

In step S44, the processor 20 may set the priority order of cooling by traveling wind in order from the battery module 11 with the higher battery maximum temperature tmax, for the battery modules 11 (the battery modules 111, 112, and 113) included in the battery pack 9. The processor 20 may determine the opening level for the shutter 12 provided together with the battery module 11, to make the opening level of the shutter 12 provided together larger, by further cooling by traveling wind, for the battery module 11 having the higher priority order (i.e., the higher battery maximum temperature tmax). The opening level may include the “large (fully open) level”, the “medium level”, and the “small level”.

For example, assume that the battery maximum temperatures tmax of the battery modules 111, 112, and 113 increase in this order (i.e., the battery module 113 has the highest battery maximum temperature tmax). In this case, in step S44, the processor 20 may set the priority order in the order of the battery modules 113, 112, and 111. The processor 20 may, for example, determine the “large level” as the opening level of the shutter 123, the “medium level” as the opening level of the shutter 122, and the “small level” as the opening level of the shutter 121.

In step S45, the processor 20 may supply data regarding the opening level determined in step S44 to the shutter driver 22 for the shutter 12 provided together with the battery module 11, to thereby control the shutter driver 22. The shutter driver 22 that has received the supplied data regarding the opening level may rotate each movable shutter part 12-4 to the tilt angle (the opening angle) corresponding to the opening level, to open each opening 12-3 into an opening state with a size corresponding to the opening angle. After the process of step S45, the processor 20 may cause the process to return to step S42.

In this manner, the battery modules 11 included in the battery pack 9 may be cooled by traveling wind with an air volume corresponding to the priority order of each battery module 11 until the maximum temperature difference ATM becomes less than the temperature difference upper limit UL. This reduces the temperature variations between the battery modules 11 (the battery modules 111, 112, 113).

In step S46, the processor 20 may set the priority order of heating by traveling wind in order from the battery module 11 with the lower battery minimum temperature tmin, for the battery modules 11 (the battery modules 111, 112, and 113) included in the battery pack 9. The processor 20 may determine the opening level for the shutter 12 provided together with the battery module 11, to make the opening level of the shutter 12 provided together larger, by further heating by traveling wind, for the battery module 11 having the higher priority order (i.e., the lower battery minimum temperature tmin). The opening level may include the “large level”, the “medium level”, and the “small level”.

In step S47, the processor 20 may supply data regarding the opening level determined in step S46 to the shutter driver 22 for the shutter 12 provided together with the battery module 11, to thereby control the shutter driver 22. The shutter driver 22 that has received the supplied data regarding the opening level may rotate each movable shutter part 12-4 to the tilt angle (the opening angle) corresponding to the opening level, to open each opening 12-3 into an opening state with a size corresponding to the opening angle. After the process of step S47, the processor 20 may cause the process to return to step S42.

In this manner, the battery modules 11 included in the battery pack 9 may be heated by traveling wind with an air volume corresponding to the priority order of each battery module 11 until the maximum temperature difference ATM becomes less than the temperature difference upper limit UL. This reduces the temperature variations between the battery modules 11 (the battery modules 111, 112, 113).

The second example embodiment makes it possible to achieve effects similar to those of the first example embodiment described above. Further, according to the second example embodiment, the corresponding shutter 12 may be opened with the size at the opening level determined based on the temperature of each battery module 11, which makes it possible to control the air volume of the traveling wind flowing toward the battery module 11 with higher accuracy. Thus, the second example embodiment makes it possible to perform the temperature control of the battery modules 11 with higher accuracy.

### Third Example Embodiment

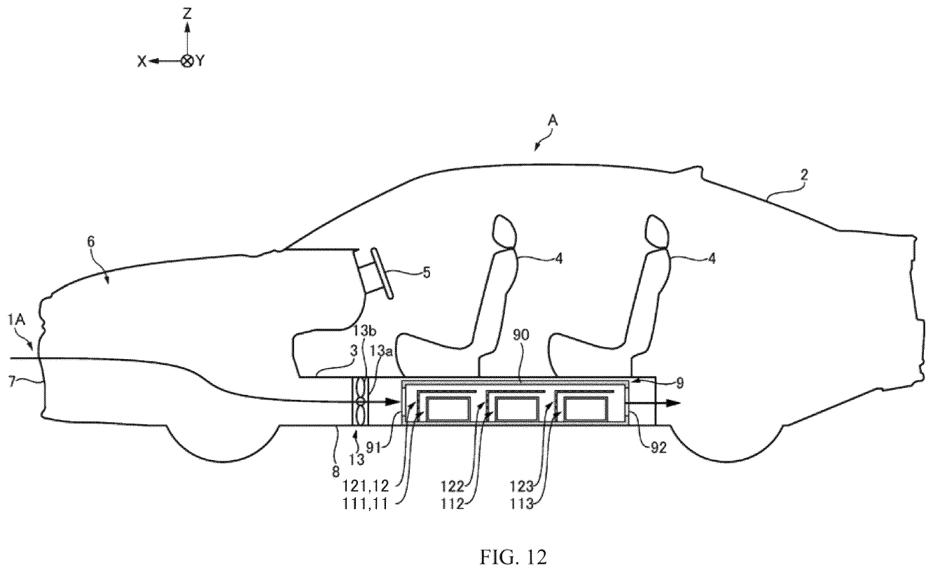

Next, a third example embodiment of the disclosure will be described. As illustrated in FIG. 12, in the third example embodiment, the vehicle A may include a vehicle battery temperature control mechanism (battery temperature control mechanism) 1A including a blower 13, instead of the battery temperature control mechanism 1 described above. Description of configurations and control details in the third example embodiment that are the same as those in the first and second example embodiments will be omitted as appropriate.

In the battery temperature control mechanism 1A according to the third example embodiment, temperature control may be performed using forced wind obtained by outside air passing through the blower 13, instead of the traveling wind in the first and second example embodiments. In the battery temperature control mechanism 1A, the blower 13 may be provided between the front grille opening 7 and the battery pack 9. In other words, the blower 13 may be provided below the floor panel 3, i.e., underfloor, on the bottom (under cover) 8, in front of the battery pack (battery container) 9. The blower 13 may have a housing 13a including a fan 13b and an unillustrated motor that drives the fan 13b. In the battery temperature control mechanism 1A, forced wind obtained by outside air blown in through the front grille opening 7 passing through the blower 13 may be blown into the battery pack 9, and the battery modules 11 in the battery pack 9 may be cooled or heated by the forced wind flowing through the battery pack 9.

Also in the battery temperature control mechanism 1A according to the third example embodiment, the shutters 12 (121, 122, and 123) may be configured to change between an open state in which forced wind flowing through the battery pack 9 hits the battery module 11 provided together, and a closed state in which the flow of the forced wind toward the battery module 11 provided together is blocked.

In the battery temperature control mechanism 1A according to the third example embodiment, the processor 20 may use forced wind instead of traveling wind to perform, for example, a shutter opening and closing control process substantially similar to the shutter opening and closing control process in a traveling vehicle illustrated in the flowchart of FIG. 5 in the first example embodiment. Note that, in this case, the processor 20 may perform the processes of steps S2 to S14 illustrated in FIG. 5 without performing the processes of steps S1 and S15, and the processor 20 may thus not perform the processes illustrated in FIG. 6.

Alternatively, in the battery temperature control mechanism 1A according to the third example embodiment, the processor 20 may use forced wind instead of traveling wind to perform a shutter opening and closing control process substantially similar to the shutter opening and closing control process in a traveling vehicle illustrated in the flowchart of FIG. 11 in the second example embodiment. Note that, in this case, the processor 20 may perform the processes of steps S32 to S48 illustrated in FIG. 11 without performing the processes of steps S31 and S49, and the processor 20 may thus not perform the processes illustrated in FIG. 6.

In another example, instead of the configuration illustrated in FIG. 12, the battery temperature control mechanism 1A according to the third example embodiment may have a configuration in which: the blower 13 is provided in front of the battery module 111 positioned furthest on the front side in the vehicle front-rear direction in the battery pack 9; and the processor 20 performs the shutter opening and closing control process in the third example embodiment.

### Fourth Example Embodiment

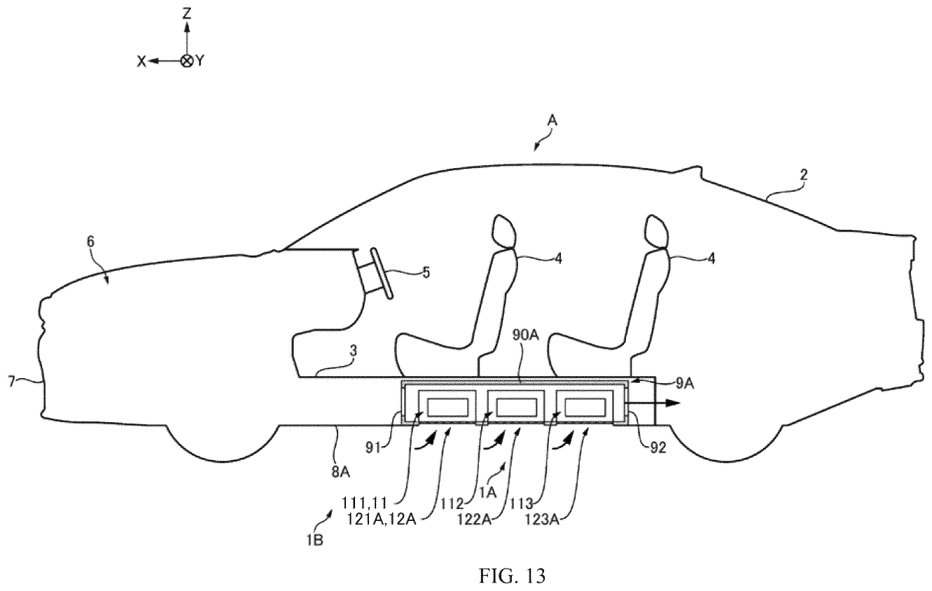

Next, a fourth example embodiment of the disclosure will be described. As illustrated in FIG. 13, in the fourth example embodiment, the vehicle A may include a vehicle battery temperature control mechanism (battery temperature control mechanism) 1B instead of the battery temperature control mechanism 1 described above. Description of configurations and control details in the fourth example embodiment that are the same as those in the first and second example embodiments will be omitted as appropriate.

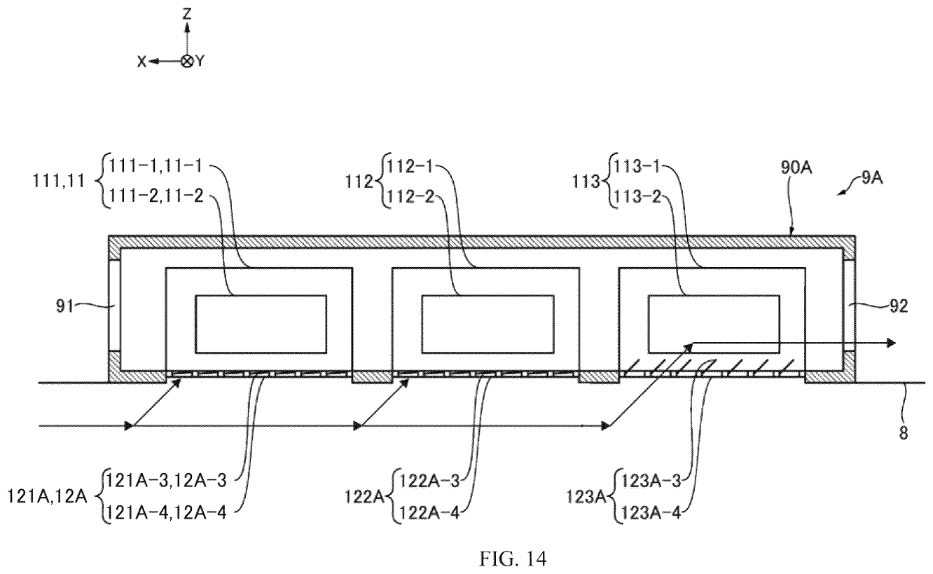

The battery temperature control mechanism 1B according to the fourth example embodiment may have openings on a bottom (under cover) 8A and a bottom surface of a housing (case) 90A of a battery pack 9A, at positions directly below the respective battery modules 11 (battery modules 111, 112, and 113). In one embodiment, the openings may each serve as an “inlet”. In the battery temperature control mechanism 1B, shutters 12A (shutters 121A, 122A, and 123A) configured to open and close may be provided for the respective openings themselves. As indicated by solid-line arrows in FIGS. 13 and 14, the battery temperature control mechanism 1B may control the temperature of the battery modules 11 by taking in outside air (including traveling wind) flowing below the vehicle A. When there is an open shutter 12A, the outside air (including traveling wind) flowing from below the vehicle A through the open shutter 12A may hit the battery module 11 provided together with the shutter 12A.

Note that, in the fourth example embodiment, outside air (including traveling wind) flowing in from the front grille opening 7 may hit, for example, equipment in the front part 6 but may not flow into the battery-pack 9A, thus not being used for the battery temperature control mechanism 1B.

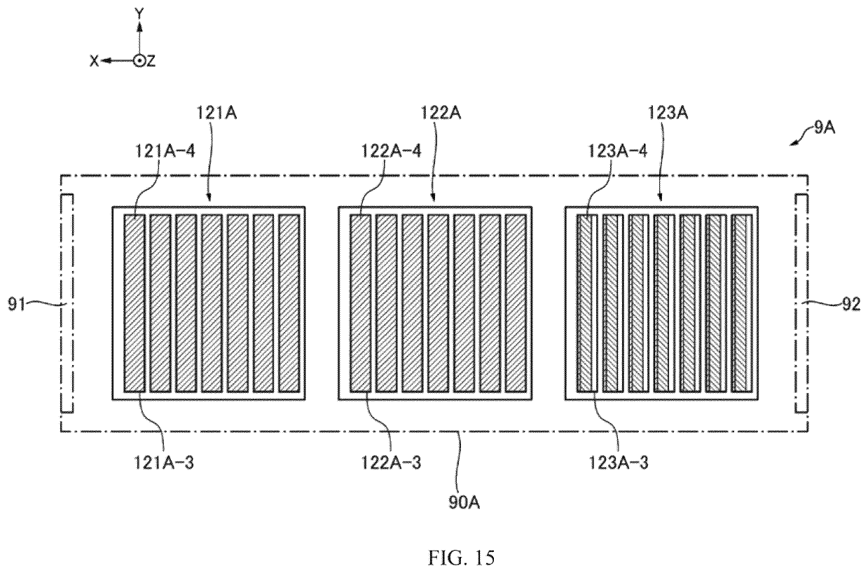

As illustrated in FIGS. 14 and 15, the shutter 12A may include multiple openings 12A-3 and movable shutter parts 12A-4 provided for the respective openings 12A-3. In other words, the shutter 121A may include multiple openings 121A-3 and movable shutter parts 121A-4 provided for the respective openings 121A-3. The shutter 122A may include multiple openings 122A-3 and movable shutter parts 122A-4 provided for the respective openings 122A-3. The shutter 123A may include multiple openings 123A-3 and movable shutter parts 123A-4 provided for the respective openings 123A-3.

In the example illustrated in FIGS. 14 and 15, in the battery pack 9A, all the movable shutter parts 121A-4 and 122A-4 of the shutters 121A and 122A provided together with the battery modules 111 and 112 close (fully close) the openings 121A-3 and 122A-3. Accordingly, outside air (traveling wind) flowing below the vehicle A may not flow into the battery-pack 9A, thus not hitting the battery modules 111 and 112.

In contrast, in the battery pack 9A of this example, all the movable shutter parts 123A-4 of the shutter 123A provided together with the battery module 113 may each be disposed at the maximum opening angle with respect to the opening surface of the opening 123A-3. All the openings 121A-3 may thus be in a state opened to the maximum (a fully open state). Accordingly, outside air (traveling wind) flowing below the vehicle A may flow into the battery pack 9A to hit the battery module 113.

Also in the battery temperature control mechanism 1B according to the fourth example embodiment, the processor 20 may control the temperature of the battery module 11 by performing a shutter opening and closing control process similar to that (FIGS. 5 and 6 or FIGS. 11 and 6) in the first example embodiment or the second example embodiment described above.

According to the fourth example embodiment, the shutters 12A (the shutters 121A, 122A, and 123A) may be provided for the openings themselves provided on the bottom 8A of the vehicle A, which makes it unnecessary to provide a space for the shutters in the battery pack 9A. In other words, the fourth example embodiment makes it possible to achieve effects similar to those of the first example embodiment or the second example embodiment described above, while reducing the battery pack 9A in size.

### Other Examples

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

In the first to fourth example embodiments described above, when performing control to heat the battery module 11, the processor 20 may heat the battery module 11 using outside air (including traveling wind) or forced wind obtained by outside air passing through the blower 13. In some embodiments, when performing control to heat the battery module 11, the processor 20 may heat the battery module 11 using, for example, heated air obtained by outside air taken in from the front grille opening 7 passing through the unillustrated components including, for example, the engine, the motor, and the heat exchanger (radiator) in the front part 6.

In addition, for example, setting positions and shapes of the shutters 12 (or the shutters 12A) are not limited to the examples in the first to fourth example embodiments described above, and may be changed within the scope of design of an air flow path desired for the temperature control of the battery modules 11. The number of the shutters 12 (or the shutters 12A) provided together with one battery module 11 may be two or more, instead of one in the examples described above. The battery modules 11 may include a battery module 11 with which no shutter 12 (or shutter 12A) is provided together.

The processor 20 illustrated in FIG. 4 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processor 20. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processor 20 illustrated in FIG. 4.

1. A vehicle battery temperature control mechanism configured to control a temperature of a vehicle battery of a vehicle, the vehicle battery temperature control mechanism comprising:
a battery set comprising battery modules arranged along a vehicle front-rear direction of the vehicle;
an inlet configured to allow outside air to be blown into the inlet;
shutters provided together with the battery modules and configured to change between an open state in which the outside air blown in through the inlet hits the battery modules and a closed state in which flow of the outside air toward the battery modules is blocked; and
a processor configured to perform an opening and closing control of controlling the shutters into the open state or the closed state.

2. The vehicle battery temperature control mechanism according to claim 1, wherein
the inlet is configured to allow traveling wind serving as the outside air to be blown into the inlet, and
the shutters are each configured to change between the open state in which the traveling wind blown in through the inlet hits the battery module provided together with the shutter, and the closed state in which flow of the traveling wind toward the battery module provided together with the shutter is blocked.

3. The vehicle battery temperature control mechanism according to claim 1, wherein
the battery set is contained in a battery pack,
the vehicle battery temperature control mechanism further comprises a blower provided between the inlet and the battery pack, or in front of the battery module positioned furthest on a front side along the vehicle front-rear direction in the battery pack,
the blower is configured to cause forced wind to flow through the battery pack, the forced wind being obtained by the outside air blown in through the inlet passing through the blower, and
the shutters are each configured to change between the open state in which the forced wind flowing through the battery pack hits the battery module provided together with the shutter, and the closed state in which flow of the forced wind toward the battery module provided together with the shutter is blocked.

4. The vehicle battery temperature control mechanism according to claim 1, further comprising a temperature sensor configured to detect a temperature of a battery cell comprised in each of the battery modules, wherein
the processor is configured to perform the opening and closing control on each of the shutters, based on the temperature of the battery cell detected by the temperature sensor.

5. The vehicle battery temperature control mechanism according to claim 2, further comprising a temperature sensor configured to detect a temperature of a battery cell comprised in each of the battery modules, wherein
the processor is configured to perform the opening and closing control on each of the shutters, based on the temperature of the battery cell detected by the temperature sensor.

6. The vehicle battery temperature control mechanism according to claim 3, further comprising a temperature sensor configured to detect a temperature of a battery cell comprised in each of the battery modules, wherein
the processor is configured to perform the opening and closing control on each of the shutters, based on the temperature of the battery cell detected by the temperature sensor.

7. The vehicle battery temperature control mechanism according to claim 4, wherein the processor is configured to
determine an opening level of each of the shutters, based on the temperature of the battery cell detected by the temperature sensor, and,
when opening each of the shutters, perform the opening and closing control to open the shutter with a size corresponding to the determined opening level.

8. The vehicle battery temperature control mechanism according to claim 5, wherein the processor is configured to
determine an opening level of each of the shutters, based on the temperature of the battery cell detected by the temperature sensor, and,
when opening each of the shutters, perform the opening and closing control to open the shutter with a size corresponding to the determined opening level.

9. The vehicle battery temperature control mechanism according to claim 6, wherein the processor is configured to
determine an opening level of each of the shutters, based on the temperature of the battery cell detected by the temperature sensor, and,
when opening each of the shutters, perform the opening and closing control to open the shutter with a size corresponding to the determined opening level.

10. The vehicle battery temperature control mechanism according to claim 1, wherein the shutters are provided together with the battery modules respectively.

11. The vehicle battery temperature control mechanism according to claim 2, wherein the shutters are provided together with the battery modules respectively.

12. The vehicle battery temperature control mechanism according to claim 3, wherein the shutters are provided together with the battery modules respectively.
